(19) United States
(12) Patent Application Publication
(10) Pub. No.: US 2022/0281319 A1
(43) Pub. Date: Sep. 8, 2022

(54) VEHICLE INTERIOR STRUCTURE

(71) Applicant: HONDA MOTOR CO., LTD., Tokyo (JP)

(72) Inventor: Ryota SHIRAI, Tokyo (JP)

(21) Appl. No.: 17/678,010

(22) Filed: Feb. 23, 2022

(30) Foreign Application Priority Data
Mar. 5, 2021 (CN) 202110244647.9

(51) Int. Cl. B60K 37/00; B60H 1/00; B60H 1/22

(52) U.S. Cl. CPC B60K 37/00; B60H 1/00792; B60H 1/2227

(57) ABSTRACT

Provided is a vehicle interior structure that can prevent a heater from reaching a high temperature even when a liquid, such as a drink, brought into a vehicle cabin spills on an Instrument panel, on which the heater is provided outside the vehicle cabin. The vehicle interior structure includes a vehicle interior member 10 and a heater 50 provided on a vehicle cabin exterior side of the vehicle interior member 10. The heater 50 is provided with temperature detection devices 56 and 57 and a waterproof film 54 that covers the temperature detection devices 56 and 57.

This application is based on and claims the benefit of priority from Chinese Patent Application No. CN202110244647.9, filed on 5 Mar. 2021, the content of which is incorporated herein by reference.

### BACKGROUND OF THE INVENTION

### Field of the Invention

The present invention relates to a vehicle interior structure.

### Related Art

There is a conventionally known vehicle in which sheet-shaped heaters are mounted on a surface, outside a vehicle cabin, of a door trim as a vehicle interior member that covers a door panel of a vehicle door.

(For example, Patent Document 1.)

In such a vehicle, the heaters are invisible to an occupant inside the vehicle cabin and therefore need not be covered with a decorative member. There is also no need to slightly depress a part of the door trim surface in order to make a surface of the door trim inside the vehicle cabin flush. Thus, a mold for the door trim can be easily processed and the cost can be reduced.

Patent Document 1: Japanese Unexamined Patent Application, Publication No. 2007-118851

### SUMMARY OF THE INVENTION

In the above conventional vehicle, the heaters are provided between the vehicle door and the door trim. On the other hand, for example, it is conceivable to directly provide a heater on a side of a vehicle interior member, such as an instrument panel., that is outside the vehicle cabin and invisible from inside of the vehicle cabin. One concern in this case is that a liquid, such as a drink, brought into the vehicle cabin may accidentally spill on the instrument panel. The liquid flows from inside to outside of the vehicle cabin through a gap in the instrument panel and comes into contact with the heater. The heater is provided with a thermistor or the like that detects the temperature of the heater. If the thermistor or the like gets wet by contact with the liquid, it can no longer correctly detect the temperature of the heater. As a result, it becomes difficult to achieve a preset predetermined temperature of the heater, and the heater is likely to reach a high temperature.

An object of the present invention is to provide a vehicle interior structure that can prevent a heater from reaching a high temperature even when a liquid, such as a drink, brought into a vehicle cabin spills on an instrument panel on which the heater is provided outside the vehicle cabin.

To achieve this object, the present invention provides a vehicle interior structure including: a vehicle interior member (e.g., a lower cover 10 of an instrument panel 1 to be described later); and a heater (e.g., a heater unit 50 to be described later) provided on a vehicle cabin exterior side of the vehicle interior member. The heater is provided with a temperature detection device (e.g., a thermistor 56 and a thermostat 57 to be described later) and a waterproof film (e.g., a waterproof film 54 to be described later) that, covers the temperature detection device.

Thus, in the case where a liquid, such as a drink, brought into the vehicle cabin spills on the vehicle interior member, the temperature detection device can be prevented from getting wet even when this liquid flows from inside to outside of the vehicle cabin through a gap in the vehicle interior member and wets the heater. As a result, a situation can be prevented where the temperature of the heater cannot be correctly detected and the temperature of the heater becomes high.

In this case, it is preferable that the temperature detection device be a thermistor (e.g., the thermistor 56 to be described later). Thus, a situation can be prevented where the thermistor covered with the waterproof film gets wet with a liquid, such as a drink, and the resistance value of the thermistor changes significantly due to the liquid.

In this case, it is preferable that the temperature detection device be a thermostat: (e.g., the thermostat 57 to be described later). Thus, a situation can be prevented where the thermostat covered with the waterproof film gets wet with a liquid, such as a drink, and is hindered from switching the ON/OFF state of power supply to the heater to keep the temperature of the heater constant.

In this case, it is preferable that the vehicle interior member be a lower cover (e.g., the lower cover 10 to be described later) of an instrument panel (e.g., the instrument panel 1 to be described later). Thus, even when an occupant riding in the vehicle spills a liquid, such as a drink, on the instrument panel, the heater provided on the lower cover of the instrument panel, outside the vehicle cabin, can be prevented from reaching a high temperature.

The present invention can provide a vehicle interior structure that can prevent a heater from reaching a high temperature even when a liquid, such as a drink, brought into a vehicle cabin spills on an instrument panel on which the heater is provided outside the vehicle cabin.

### BRIEF DESCRIPTION OF THE DRAWINGS

FIG. 1 is an illustration showing a lower cover, a steering column cover, and a lid of a glove compartment of an instrument panel having a vehicle interior structure as one embodiment of the present invention, as seen from outside a vehicle cabin; and

FIG. 2 is an illustration showing a heater unit in the vehicle interior structure as one embodiment of the present invention.

### DETAILED DESCRIPTION OF THE INVENTION

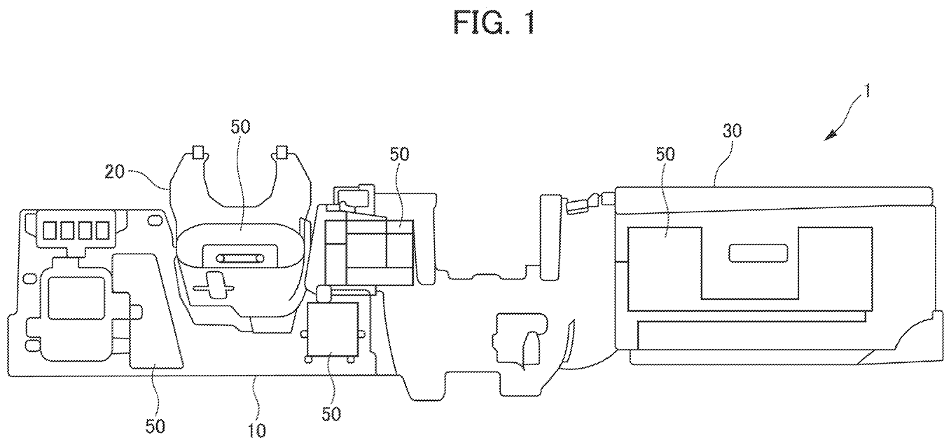

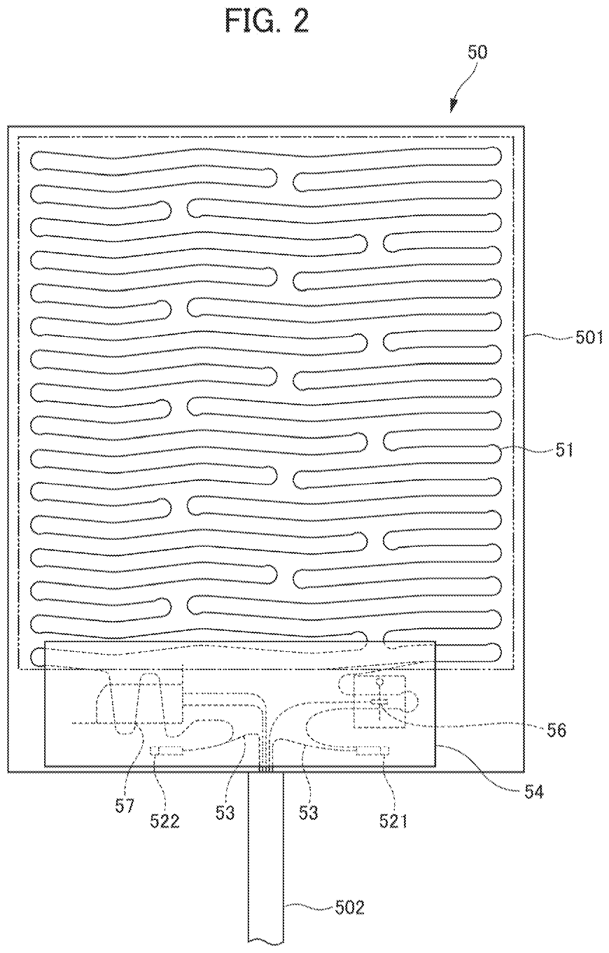

An embodiment of the present invention will be specifically described below with reference to the drawings. FIG. 1 is an illustration showing a lower cover 10, a steering column cover 20, and a lid 30 of a glove compartment of an instrument panel 1 having a vehicle interior structure, as seen from outside a vehicle cabin. FIG. 2 is an illustration showing a heater unit 50 In the vehicle interior structure.

As shown in FIG. 1, the vehicle interior structure is provided in the lower cover 10, the steering column cover 20, and the lid 30 of the glove compartment of the instrument panel 1 as a vehicle interior member. Heater units 50 are provided on the lower cover 10, the column cover 20, and the lid 30 of the glove compartment of the instrument panel 1, on their surfaces outside the vehicle cabin by being attached thereto.

More specifically, as shown in FIG. 1, the heater unit 50 is provided at a lower part of the steering column cover 20 located near the knee and the thigh of an occupant in a driver's seat of a vehicle, on a surface thereof outside the vehicle cabin (a surface on the opposite side from a surface facing the knee and the thigh of the occupant in the driver's seat of the vehicle).

The heater units 50 are provided at parts of the lower cover 10 of the instrument panel 1 located on left and right sides of the steering column cover 20, on a surface thereof outside the vehicle cabin (a surface of the lower cover 10 on the opposite side from a surface thereof facing the knee and the thigh of the occupant in the driver's seat of the vehicle).

The heater unit 50 is provided on the lid 30 of the glove compartment, on a surface thereof outside the vehicle cabin (a surface of the lid 30 of the glove compartment on the opposite side from a surface thereof facing the knee and the thigh of an occupant in a front passenger's seat of the vehicle).

The heater unit 50 has a main body 501 and a cord 502, and includes an electric heating wire 51, a terminal 521 and a terminal 522, stretchable tubes 53 with a conductive wire passed inside, a waterproof film 54, a thermistor 56, and a thermostat 57.

In the main body 501, the electric heating wire 51, the terminal 521 and the terminal 522, the stretchable tubes 53 with the conductive wire passed therethrough, the waterproof film 54, the thermistor 56, and the thermostat 57 are disposed. The electric heating wire 51 has a predetermined resistance value, and generates heat as electricity is supplied thereto. One end and the other end of the electric heating wire 51 are respectively electrically connected to the terminal 521 and the terminal 522.

End portions of the conductive wires inside the stretchable tubes 53 are respectively electrically connected to the terminal 521 and the terminal 522. The conductive wires inside the stretchable tubes 53 pass through an inside of the cord 502 and are electrically connected to a power source (not shown). As power is supplied from the power source (not shown) to the conductive wires inside the cord 502, power is supplied to the electric heating wire 51 through the conductive wires inside the stretchable tubes 53.

As shown in FIG. 2, the thermistor 56 as a temperature detection device is disposed at a part near the end portion of the electric heating wire 51 that is electrically connected to the terminal 521. The resistance value of the thermistor 56 changes as the temperature of this part at the end portion of the electric heating wire 51 changes. Thus, a current applied to the electric heating wire 51 is controlled by the thermistor 56 to thereby control the temperature of the electric heating wire 51.

As shown in FIG. 2, the thermostat 57 as a temperature detection device is disposed at a part near the end portion of the electric heating wire 51 that is electrically connected to the terminal 522. The thermostat 57 includes a bimetal, a thermistor, or the like, and deforms as the temperature of the electric heating wire 51 changes, thereby switching the ON/OFF state of power supply to the electric heating wire 51 so as to keep the temperature of the electric heating wire 51 constant.

The thermistor 56, the thermostat 57, portions of the electric heating wire 51 near the thermistor 56 and the thermostat 57, the terminal 521 and the terminal 522, and the stretchable tubes 53 with the conductive wire passed therethrough are covered with the waterproof film 54 so as to be surrounded by the waterproof film 54. Even when a liquid, such as a drink, flowing into the side of the lower cover 10 outside the vehicle cabin through a gap in the instrument panel 1 reaches the heater unit 50, this configuration can prevent the thermistor 56 and the thermostat 57 from getting wet with the liquid.

This embodiment can offer the following advantages. In this embodiment, the vehicle interior structure has the heater units 50 provided on the lower cover 10, the steering column cover 20, and the lid 30 of the glove compartment of the instrument panel 1 as a vehicle interior member, outside the vehicle cabin. Each heater unit 50 is provided with the thermistor 56 and the thermostat 57 as temperature detection devices and the waterproof film 54 that covers the thermistor 56 and the thermostat 57.

Thus, in the case where a liquid, such as a drink, brought into the vehicle cabin spills on the instrument panel 1, the thermistor 56, the thermostat 57, portions of the electric heating wire 51 near the thermistor 56 and the thermostat 57, the terminal 521 and the terminal 522, and the stretchable tubes 53 with the conductive wire passed therethrough can be prevented from getting wet even when this liquid fiows from inside to outside of the vehicle cabin through a gap in the instrument panel 1 and wets the heater unit 50. As a result, a situation can be prevented where the temperature of the electric heating wire 51 cannot be correctly detected and the temperature of the electric heating wire 51 becomes high.

In this embodiment, the temperature detection device is the thermistor 56. Thus, a situation can be prevented where the thermistor 56 covered with the waterproof film 54 gets wet with a liquid, such as a drink, and the resistance value of the thermistor 56 changes significantly due to the liquid.

In this embodiment, the temperature detection device is the thermostat 57. Thus, a situation can be prevented where the thermostat 57 covered with the waterproof film 54 gets wet with a liquid, such as a drink, and is hindered from switching the ON/OFF state of power supply to the electric heating wire 51 to keep the temperature of the electric heating wire 51 constant.

In this embodiment, the vehicle interior member is the lower cover 10 of the instrument panel 1. Thus, even when an occupant riding in the vehicle spills a liquid, such as a drink, on the instrument panel 1, the electric heating wire 51 of the heater unit 50 provided on the lower cover 10 of the instrument panel 1, outside the vehicle cabin, can be prevented from reaching a high temperature.

The present invention is not limited to the above embodiment, and modifications, improvements, etc. within such a range that the object of the present invention can be achieved are included in the present invention. For example, the vehicle interior member, the heater, the temperature detection device, the waterproof film, etc. are not limited to the lower cover 10 of the Instrument panel 1, the heater unit 50, the thermistor 56 and the thermostat 57, the waterproof film 54, and the like in the embodiment

### EXPLANATION OF REFERENCE NUMERALS

1 Instrument panel
10 Lower cover
50 Heater unit
54 Waterproof film
56 Thermistor (temperature detection device)
57 Thermostat (temperature detection device)

What is claimed is:

1. A vehicle interior structure comprising: a vehicle interior member; and a heater provided on a vehicle cabin exterior side of the vehicle interior member,
wherein the heater is provided with a temperature detection device and a waterproof film that covers the temperature detection device.

2. The vehicle interior structure according to claim 1, wherein the temperature detection device is a thermistor.

3. The vehicle interior structure according to claim 1, wherein the temperature detection device is a thermostat.

4. The vehicle interior structure according to claim 1, wherein the vehicle interior member is a lower cover of an instrument panel.
